(19) United States
(12) Patent Application Publication
(10) Pub. No.: US 2014/0212020 A1
(43) Pub. Date: Jul. 31, 2014

(54) PHOTOLUMINESCENCE IMAGING OF DOPING VARIATIONS IN SEMICONDUCTOR WAFERS

(71) Applicant: Juergen Weber, Coogee (AU)

(72) Inventor: Juergen Weber, Coogee (AU)

(73) Assignee: BT IMAGING PTY LTD, Haymarket, New South Wales (AU)

(21) Appl. No.: 14/238,213

(22) PCT Filed: Aug. 10, 2012
(86) PCT No.: PCT/AU2012/000940

§ 371 Date: Feb. 11, 2014

(30) Foreign Application Priority Data
Aug. 12, 2011 (AU) 2011903226

(51) Int. Cl. G06T 7/00

(52) U.S. Cl. CPC G06T 7/0004
USPC 382/145

(57) ABSTRACT

Photoluminescence-based methods are presented for facilitating alignment of wafers during metallisation in the manufacture of photovoltaic cells with selective emitter structures, and in particular for visualising the selective emitter structure prior to metallisation. In preferred forms the method is performed in-line, with each wafer inspected after formation of the selective emitter structure to identify its location or orientation. The information gained can also be used to reject defective wafers from the process line or to identify a systematic fault or inaccuracy with the process used to form the patterned emitter structure. Each wafer can additionally be inspected via photoluminescence imaging after metallisation, to determine whether the metal contacts have been correctly positioned on the selective emitter structure. The information gained after metallisation can also be used to provide feedback to the upstream process steps.

### FIELD OF THE INVENTION

The present invention relates to systems and methods for identifying doping variations in semiconductor wafers, and in particular to systems and methods for determining the position or orientation of selective emitter structures on semiconductor wafers prior to metallisation in the manufacture of photovoltaic cells. However the invention is not limited to this particular field of use.

### RELATED APPLICATIONS

The present application claims priority from Australian Provisional Patent Application No 2011903226, filed on 12 Aug. 2011, the contents of which are incorporated herein by reference.

### BACKGROUND OF THE INVENTION

Any discussion of the prior art throughout this specification should in no way be considered as an admission that such prior art is widely known or forms part of the common general knowledge in the field.

Crystalline semiconductor photovoltaic (PV) cells generally have a pn-junction just below their front surface, typically formed by in-diffusion of a dopant of opposite polarity to the background doping of the semiconductor material. Apart from creating the pn-junction, the resulting ‘emitter layer’ also serves to transport charge carriers to and into the metal finger contacts on the front surface. Most commercially available PV cells are based on boron-doped (p-type) multi-crystalline silicon wafers, with an n⁺⁺-type layer formed by thermal diffusion of phosphorus into the surface. However the typically highly doped emitter layer has low carrier lifetime and absorbs a significant proportion of the high energy (UV and blue) portion of the solar spectrum, thus causing a reduction in cell efficiency of about 1% in absolute terms (e.g. from 18% to 17%). For high efficiency cells, it is therefore desirable to form an emitter layer in selective fashion, lightly doped (for reduced blue response loss) in all areas except where the metal lines are to be deposited. Furthermore the lightly doped emitter regions generally have a lower emitter saturation current, which increases the open circuit voltage of the cell compared to a standard, highly doped uniform emitter.

A number of techniques are known for forming selective emitter structures in or on the surface of silicon wafers. In one technique a phosphorus-containing paste is ink-jet printed onto the p-type silicon surface, followed by thermal diffusion. In another technique, described in U.S. Pat. No. 7,910,393, a doped nano-particle silicon ink is screen printed and crystallised to form a highly doped layer. Some other techniques form a selective emitter by local diffusion using a laser (as described in U.S. Pat. No. 6,429,037 and published US patent application No 2010/0144079 A1), or by masked ion implantation (published US patent application No 2010/0297782 A1). In yet another technique, described in T. Lauermann et al ‘InSECT: An Inline Selective Emitter Concept with High Efficiencies at Competitive Process Costs Improved with Inkjet Masking Technology’, 24^{th} European Photovoltaic Solar Energy Conference, 21-25 Sep. 2009, Hamburg, Germany, pp. 1767-1770, a pattern of etch-resistant wax is ink-jetted onto a phosphorus-doped surface layer, and the unprotected surface layer partially etched away before removal of the wax.

As shown schematically in FIGS. 1A and 1B, once a patterned emitter structure 2 has been formed on the surface of a silicon wafer 4, the metal fingers 6 and bus bars 8 are deposited, often by screen printing, followed by contact firing to complete the fabrication of a PV cell. The metal lines 6, 8 need to be formed on top of the patterned emitter structure 2 as shown in FIG. 1B, or else the contact resistance will be excessively high, significantly reducing the efficiency of the PV cell; the effect of metal contact misalignment on several PV cell parameters has been reported in A. Meisel et al ‘Impact of metal contact misalignment in silicon ink selective emitter solar cells’, 35^{th} IEEE Photovoltaic Specialists Conference, 20-25 Jun. 2010, Hawaii, USA, pp. 1456-1460. However in at least some selective emitter techniques the patterned emitter structure is difficult if not impossible to discern because the compositional variations are invisible and there is minimal surface relief or other visible change in surface appearance. In such cases the metallisation screen printer has to rely on means such as mechanical stops for sample alignment and, as shown in FIG. 1B, the individual highly doped emitter regions 10 are invariably over-sized to provide an alignment tolerance. For example emitter lines may be 350 μm wide to accommodate 150 μm wide metal fingers. However irrespective of the spatial accuracy of the screen printer, if the patterned emitter structure is significantly misaligned in the first place, e.g. if the wafer is not oriented correctly or moves during the emitter patterning process, then the metal contacts will be deposited in the wrong place resulting in a reject cell or at least a loss in efficiency. A second problem with some of the current selective emitter methods is the blue absorption and emitter recombination in the over-sized emitter lines; PV cell efficiency could be pushed even higher if the alignment tolerance could be reduced or dispensed with.

There is a need therefore for improved methods for manufacturing selective emitter PV cells. In particular, in at least some selective emitter PV cell manufacturing techniques there is a need for a method for facilitating wafer alignment during metallisation of a selective emitter structure.

### SUMMARY OF THE INVENTION

It is an object of the present invention to overcome or ameliorate at least one of the disadvantages of the prior art, or to provide a useful alternative. It is an object of the present invention in its preferred form to provide systems and methods for facilitating wafer alignment during metallisation of selective emitter structures in the manufacture of photovoltaic cells.

In accordance with a first aspect of the present invention there is provided a method for identifying variations in doping in a semiconductor material, said method comprising the steps of:

(a) illuminating said material with excitation light suitable for generating photoluminescence from said material;

(b) acquiring an image of the photoluminescence emitted from said material; and

(c) identifying said variations in doping based on a differential in said image.

The differential preferably comprises an intensity contrast. Alternatively, the differential comprises a wavelength variation.

In one preferred form, the method further comprises the step of: (d) forming on the material one or more optically visible markings indicative of the identified variations in doping. In an alternative form, the method further comprises the step of: (e) determining the relative position between the identified variations in doping and one or more optically visible markings on the material. Preferably, the method further comprises the step of: (f) utilising the identified variations in doping, or the optically visible markings, to align the material for a subsequent step in the manufacture of a device from the material. In one preferred form, the method further comprises the step of: (g) processing the image to obtain information on dislocations, cracks or low carrier lifetime regions in the material. Preferably, the method further comprises the step of: (h) utilising the identified variations in doping, or the information on dislocations, cracks or low carrier lifetime regions, to reject the material or to adjust a parameter of a process step that produced the variations in doping.

The method is preferably used to identify variations in doping comprising the position or orientation of a pattern of differently doped regions formed in or on a surface of the material. More preferably, the differently doped regions are in or on the surface of the material being illuminated and imaged. In preferred forms the differently doped regions contain a dopant of opposite polarity to a background dopant in the material. In preferred embodiments the method is applied to a material comprising a monocrystalline or multicrystalline silicon wafer or photovoltaic cell. In certain forms the image is acquired from a sub-area of the material.

In accordance with a second aspect of the present invention there is provided a method for identifying a selective emitter structure on a semiconductor wafer, said method comprising the steps of:

(a) illuminating said wafer with excitation light suitable for generating photoluminescence from said wafer;

(b) acquiring an image of the photoluminescence emitted from said wafer; and

(c) identifying, based on a differential in said image, the position or orientation of said selective emitter structure.

The differential preferably comprises an intensity contrast. Preferably, the selective emitter structure is in or on the surface of the wafer being illuminated and imaged. In one preferred form the method further comprises the step of: (d) processing the image to obtain information on dislocations, cracks or low carrier lifetime regions in the wafer. Preferably, the method further comprises the step of: (e) utilising the identified position or orientation of the selective emitter structure, or the information on dislocations, cracks or low carrier lifetime regions, to adjust a parameter of a process step that produced the selective emitter structure. In one preferred form the method further comprises the step of: (f) forming on the wafer one or more optically visible markings indicative of the position or orientation of the selective emitter structure. In an alternative form the method further comprises the step of: (g) determining the relative position between the selective emitter structure and one or more optically visible markings on the material. Preferably, the method further comprises the step of: (h) utilising the identified position or orientation of the selective emitter structure, or the optically visible markings, to align the wafer for a subsequent metallisation step or for a step that facilitates a subsequent metallisation step. The method may further comprise the step of: (j) acquiring a photoluminescence image of the wafer after the metallisation step.

In accordance with a third aspect of the present invention there is provided a method for manufacturing a selective emitter photovoltaic cell, said method comprising the steps of:

(a) illuminating a semiconductor wafer with excitation light suitable for generating photoluminescence from said wafer, said wafer having a selective emitter structure;

(b) acquiring an image of the photoluminescence emitted from said wafer;

(c) identifying, based on a differential in said image, the position or orientation of said selective emitter structure; and

(d) utilising the identified position or orientation of said selective emitter structure to align said wafer for a subsequent metallisation step or for a step that facilitates a subsequent metallisation step.

Preferably, the differential comprises an intensity contrast.

In accordance with a fourth aspect of the present invention there is provided, in a manufacturing line for producing selective emitter photovoltaic cells, a method for aligning a semiconductor wafer for a metallisation step or for a step that facilitates a metallisation step, said wafer having a selective emitter structure, said method comprising the steps of:

(a) illuminating said wafer with excitation light suitable for generating photoluminescence from said wafer;

(b) acquiring an image of the photoluminescence emitted from said wafer;

(c) identifying, based on a differential in said image, the position or orientation of said selective emitter structure; and

(d) utilising the identified position or orientation of said selective emitter structure to align said wafer for said metallisation step or for a step that facilitates said metallisation step.

Preferably, the differential comprises an intensity contrast. The selective emitter structure is preferably in or on the surface of the wafer being illuminated and imaged.

In accordance with a fifth aspect of the present invention there is provided a method for monitoring a process for producing variations in doping in a semiconductor material, said method comprising the steps of:

(a) illuminating said material with excitation light suitable for generating photoluminescence from said material;

(b) acquiring an image of the photoluminescence emitted from said material; and

(c) identifying, based on a differential in said image, variations in doping produced by said process.

The differential preferably comprises an intensity contrast. Alternatively, the differential comprises a wavelength variation.

In one preferred form, the method is performed while the variations in doping are being produced. In another preferred form, the method is used to monitor the formation of a selective emitter structure in or on a surface of the material. The image may be acquired from a sub-area of the material.

In accordance with a sixth aspect of the present invention there is provided a method for identifying a metal pattern on the rear surface of a semiconductor material, said method comprising the steps of:

(a) illuminating the front surface of said material with excitation light suitable for generating photoluminescence from said material;

(b) acquiring an image of the photoluminescence emitted from said material; and

(c) identifying, based on an intensity contrast in said image, the position or orientation of said metal pattern.

Preferably, the method further comprises the step of: (d) identifying, based on a differential in the image, variations in doping in the material. The differential preferably comprises an intensity contrast. In one preferred form, the method further comprises the step of: (e) determining the relative positions of the metal pattern and the variations in doping.

In accordance with a seventh aspect of the present invention there is provided a system when used to perform the method according to any one of aspects one to six.

In accordance with an eighth aspect of the present invention there is provided an article of manufacture comprising a computer usable medium having a computer readable program code configured to perform the method according to any one of aspects one to six, or operate the system according to the seventh aspect.

### BRIEF DESCRIPTION OF THE DRAWINGS

Benefits and advantages of the present invention will become apparent to those skilled in the art to which this invention relates from the subsequent description of exemplary embodiments and the appended claims, taken in conjunction with the accompanying drawings, in which:

FIG. 1A shows in schematic plan view a silicon wafer with a patterned emitter structure;

FIG. 1B shows in schematic plan view a silicon wafer with metal lines deposited on a patterned emitter structure;

FIG. 2 shows a PL image of a p-type monocrystalline silicon wafer with a phosphorus-doped patterned emitter structure on the front surface;

FIG. 3 shows a PL image of a completed PV cell with a selective emitter structure and metal contacts on the front surface;

FIG. 4 shows in schematic side view an area-imaging system for PL imaging of a silicon wafer;

FIG. 5 shows in schematic side view a line-scanning system for PL imaging of a silicon wafer;

FIG. 6 shows a PL image of a p-type monocrystalline silicon wafer with a phosphorus-doped patterned emitter structure on the front surface, acquired in line-scanning fashion; and

FIG. 7 shows a PL image of the same wafer as in FIG. 6, but with the wafer turned over so that the emitter structure is on the rear surface.

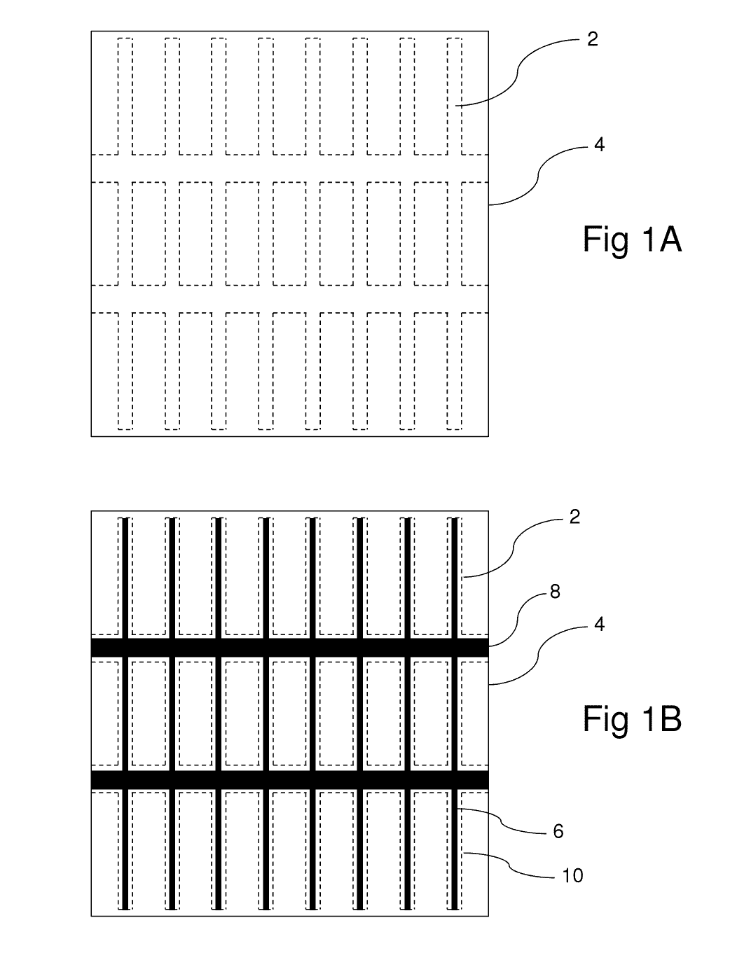

### DETAILED DESCRIPTION

Preferred embodiments of the invention will now be described, by way of example only, with reference to the accompanying drawings.

Photoluminescence (PL) imaging is known to be a rapid and convenient technique for characterising semiconductor samples such as silicon bricks, wafers and thin films, and in particular silicon-based PV cells both during and after manufacture. As discussed in T. Trupke et al ‘Progress with Luminescence Imaging for the Characterisation of Silicon Wafers and Solar Cells’, 22^{nd} European Photovoltaic Solar Energy Conference, Milan, September 2007, the PL emission from silicon samples can provide information on many material and electrical parameters of relevance to PV cell performance, including minority carrier diffusion length, minority carrier lifetime, series resistance, shunts, impurities, dislocations and cracks. The PL emission from silicon arises primarily from band-to-band recombination in the wavelength range 900 to 1300 nm, although emission at longer wavelengths can also occur from defects such as dislocations. Suitable apparatus and methods for performing PL imaging of silicon and other semiconductor materials are described in published PCT patent application Nos WO 2007/041758 A1, WO 2011/079353 A1 and WO 2011/079354 A1, the contents of which are incorporated herein by reference.

In simplest form, PL imaging of a semiconductor material involves illuminating a substantial portion or the entirety of a surface of the material with light chosen to generate PL from the material (typically above band-gap light for generating band-to-band PL), and acquiring or capturing an image of the PL emitted in response to the illumination. If desired the images can then be processed to highlight or obtain a measure of one or more features of interest.

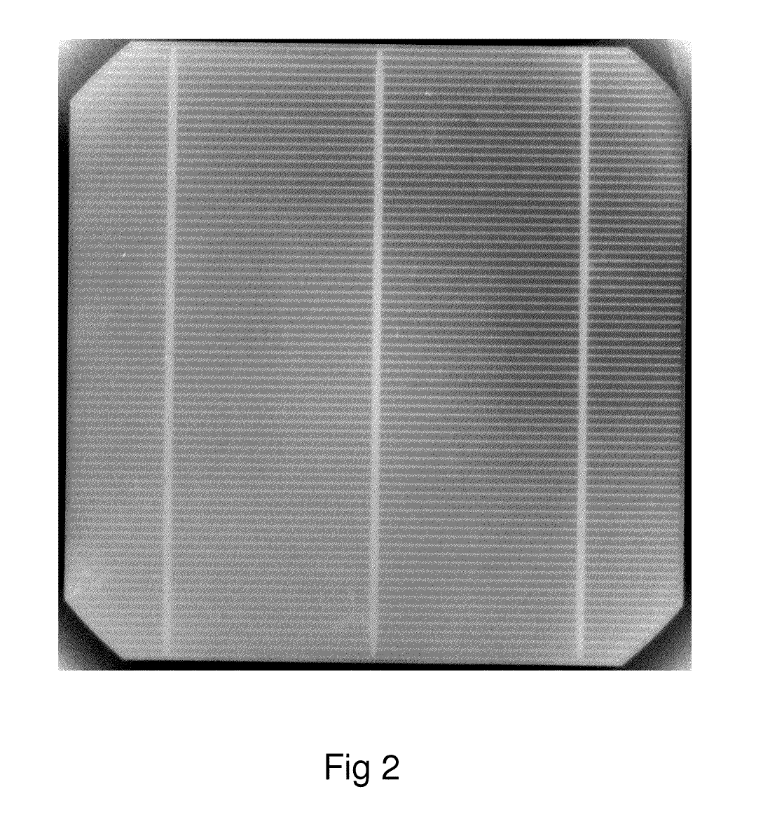

When depositing metal fingers and bus bars on a PV wafer with a previously patterned selective emitter structure, it would be beneficial to be able to identify where the highly doped regions are, and preferably do so at production line speed, to ensure the metal is deposited in the correct locations. However because a selective emitter structure is simply a pattern of compositional variations, often with little or no surface relief, optical imaging cannot always discern the position or orientation of selective emitter structures on PV cell precursors. As demonstrated by the photoluminescence image shown in FIG. 2 however, a phosphorus-doped selective emitter structure on the front surface of a monocrystalline silicon wafer is clearly revealed by lateral variations in the intensity of band-to-band PL generated by near IR illumination. Notably, the selective emitter structure on this wafer could not be discerned optically.

The ability of PL imaging to reveal the position or orientation of selective emitter structures is expected to be of value to PV cell manufacturers in a number of ways:

(1) PL imaging could be used in feed forward fashion, optionally with an additional step of depositing some form of optically visible marks (e.g. alignment marks or fiducials) for a machine vision system, to ensure wafers are correctly aligned for a subsequent metallisation step, e.g. screen printing. In preferred embodiments these alignment marks would be indicative of the position or orientation of the selective emitter structure, and may be formed for example by printing or laser scribing. In other embodiments, where alignment marks are already present on the sample wafer, e.g. to guide the selective emitter patterning process, relative position information between the selective emitter and the alignment marks is calculated and fed forward to the screen printer. If a selective emitter structure is simply misaligned slightly, e.g. because the wafer was in the wrong position in the emitter patterning step, the wafer alignment can be adjusted prior to metallisation, effectively salvaging the cell. On the other hand if a serious emitter patterning error such as incomplete printing is detected, or the wafer cannot be re-oriented, the faulty wafer can at least be detected and rejected before metallisation, saving process resources. In a closely related embodiment, the PL-derived information on the position or orientation of a selective emitter structure is used to guide a process step that facilitates subsequent metallisation. For example in one selective emitter process silicon nitride is used as a plating mask, with the silicon nitride patterned by laser ablation to allow the plating solution to deposit on the selective emitter structure.

(2) If emitter patterning errors are detected in all or a significant fraction of wafers, this would suggest a problem with the emitter patterning process enabling corrective action to be taken, saving wafers as well as process resources.

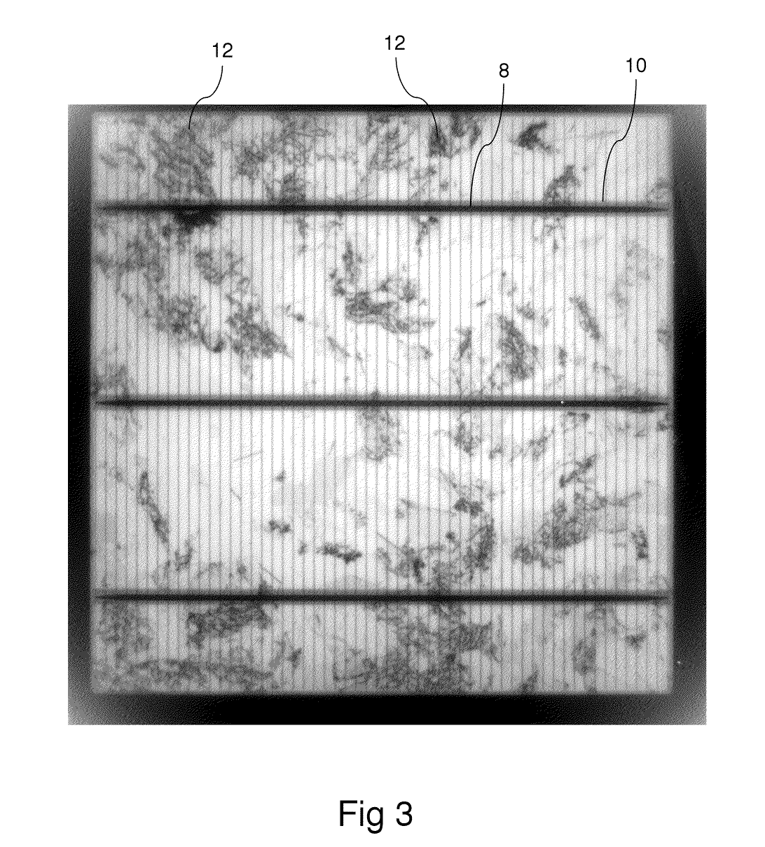

(3) PL images can also be acquired after metallisation, to ensure the metal contacts have been correctly deposited on the doped regions. FIG. 3 shows a PL image of a completed multicrystalline silicon PV cell, revealing the bus bars 8 correctly deposited within the selective emitter regions 10. The PL image also shows a number of complex low PL intensity regions 12 indicative of dislocation clusters. Cells where the metal contacts have not been correctly deposited can be rejected at an earlier stage, i.e. before poor efficiency is noticed at the final I-V testing stage of cell production, and information about insufficient alignment accuracy can be fed back to the metallisation process. Post-metallisation imaging can also be used to detect systematic drift in the metallisation process, caused for example by deformation or stretching of a print screen.

(4) By enabling precise alignment at the metallisation stage, it should be possible to reduce the width of the highly doped emitter lines, thereby reducing blue absorption and boosting overall cell efficiency.

(5) PL images acquired after the emitter formation or metallisation steps, possibly in comparison with images acquired before these process steps, may reveal other defects, in particular cracks, induced during these steps, enabling defective cells to be rejected. Cracking in a large number of samples would indicate a problem with one or other of the process steps, allowing corrective action to be taken. Other defects that may be of concern to a PV cell manufacture include dislocations and regions of low carrier lifetime material.

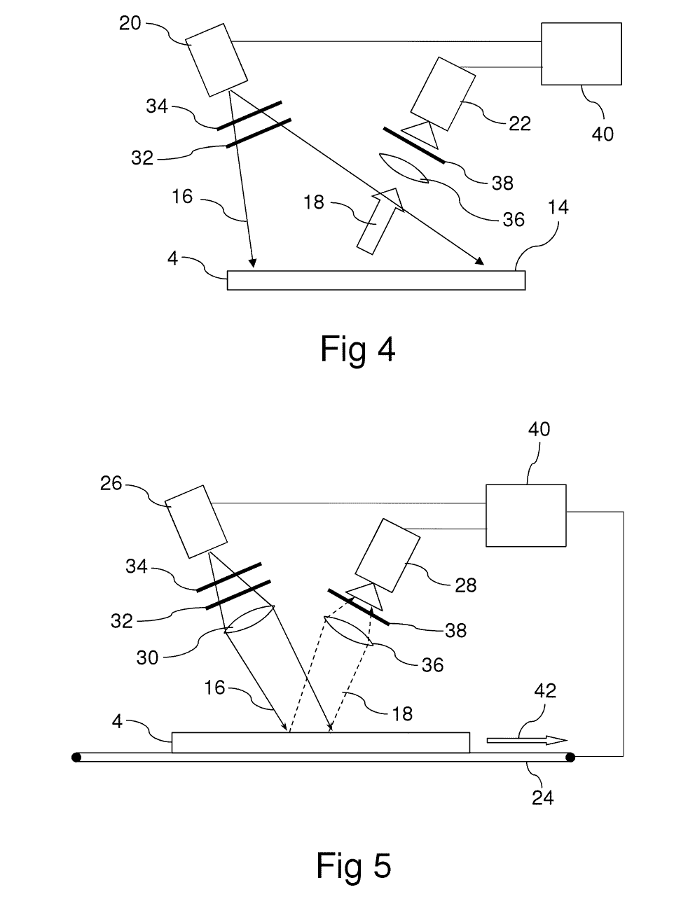

In certain embodiments PL images are acquired with an ‘area imaging’ system where, as shown in schematic side view in FIG. 4, the entire area of a silicon wafer 4 with a selective emitter structure formed in or on the front surface 14 is illuminated with light 16 suitable for generating photoluminescence 18 from the wafer material, e.g. from one or more laser or LED sources 20, and a PL image of the wafer acquired in a single exposure with an area camera such as a silicon CCD camera 22, as described for example in the above-mentioned published PCT patent application No WO 2007/041758 A1. The PL images shown in FIGS. 2 and 3 were acquired in this fashion. Area imaging is well suited to ‘off-line’ applications, e.g. trouble-shooting defective wafers or when testing a new process station. Alternatively, as described in the above-mentioned published PCT patent application No WO 2011/079353 A1, the area imaging approach can be adapted to ‘in-line’ inspection of wafers on PV cell lines, which currently operate at speeds of up to 3,600 wafers per hour, by either bringing each wafer to a stop momentarily or, more preferably, using sufficiently short and intense illumination, e.g. a pulse from a flash lamp, to minimise image blurring. In alternative embodiments suitable for in-line inspection, described in the above-mentioned published PCT patent application No WO 2011/079354 A1, wafers are imaged with a line-scanning system. As shown in schematic side view in FIG. 5, a silicon wafer 4 in motion on a system of transport belts 24 is illuminated line-by-line, e.g. with a linear light source such as an LED array 26, and the PL 18 imaged line-by-line with a line camera or a time delay integration (TDI) camera 28. Note that since any linear light source has a finite width, an illuminated line is considered to be an illuminated area. PL emission across a sample can also be mapped in point-wise fashion with a small area excitation beam (e.g. a focused laser beam) scanned across the sample surface, in which case a simple photo-detector can be used to detect the PL emission from each point.

In general, a PL imaging system may also include beam-shaping optics 30, a short pass filter 32 and a homogeniser 34 in the excitation path, collection optics 36 and a long pass filter 38 in the imaging path, and a computer 40 programmed to control the excitation source and camera and to process the acquired PL images. In line-scanning systems with TDI cameras the computer can also synchronise the camera interrogation with the wafer motion 42.

In yet other embodiments, PL images can be acquired from one or more specific sub-areas of a wafer, for example to inspect selected portions of a selective emitter pattern. In certain embodiments one or more specific sub-areas of a wafer can be imaged with higher spatial resolution, while the entire wafer is imaged with normal resolution. In certain embodiments one or more sub-areas which contain part of a selective emitter pattern and, optionally, one or more alignment marks if present, can be imaged with high spatial resolution, and the orientation and position of the entire selective emitter pattern inferred from those images.

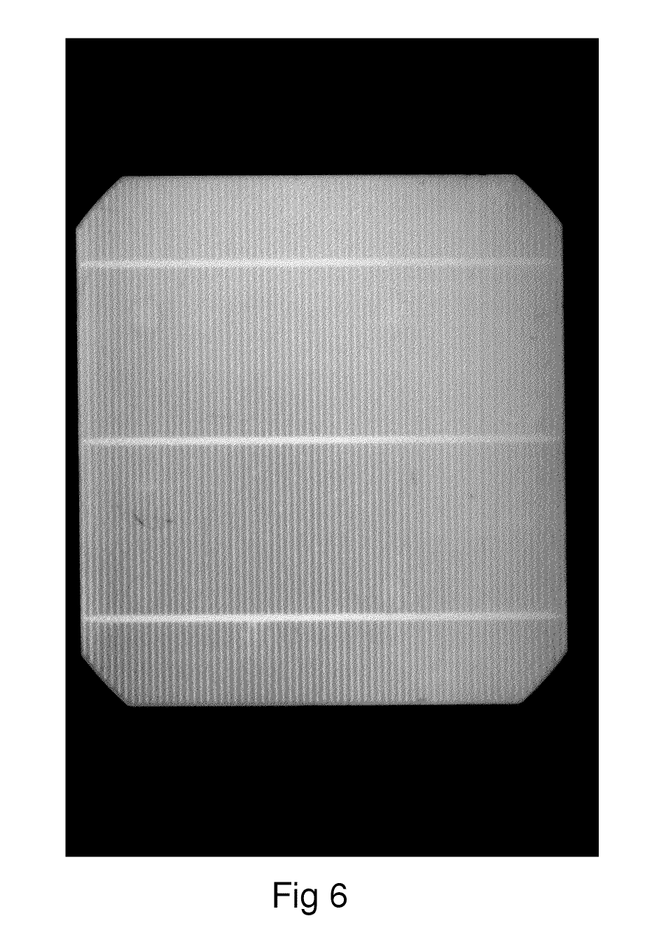

FIG. 6 shows a PL image of a monocrystalline silicon wafer with a phosphorus-doped selective emitter structure on the front surface, acquired in line-scanning fashion with a silicon TDI camera. The wafer was scanned at 200 mm/s under an 8 mm wide line of near-IR excitation light with an intensity of 10 Suns. Similar to the static PL image shown in FIG. 2, the selective emitter structure is clearly revealed.

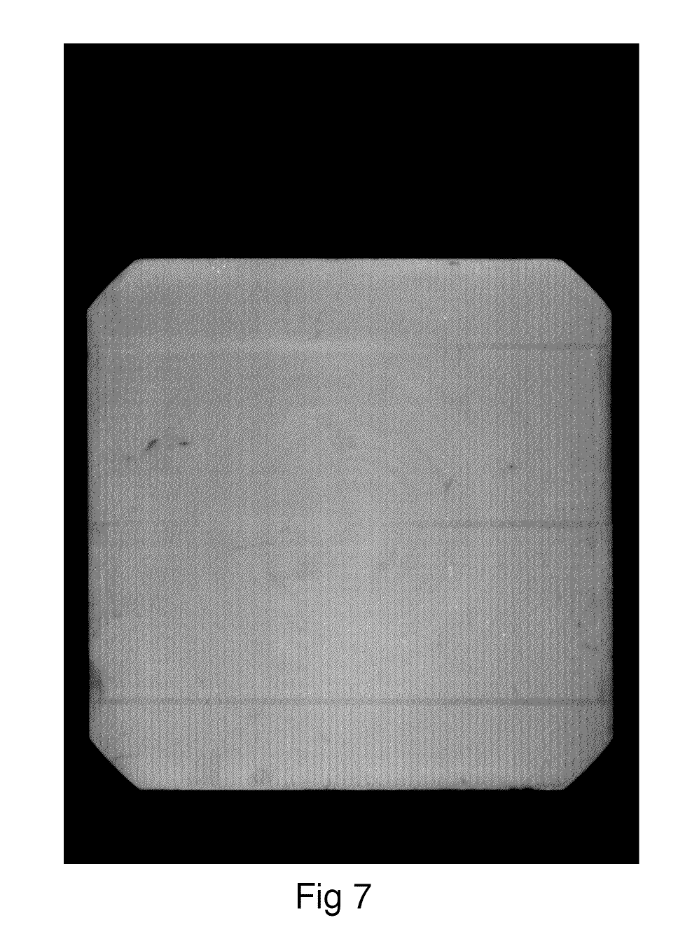

FIG. 7 shows a PL image of the same sample as that shown in FIG. 6, except that in this case the wafer has been turned over so that the illumination is applied to and the image acquired from the surface opposite to that on which the selective emitter structure is formed. A slower line scan speed of 25 mm/s was used to counteract the reduced PL intensity caused by the higher non-radiative surface recombination rate of the unpassivated rear surface compared to the diffused front surface. Although the selective emitter structure is not as clear as in the FIG. 6 image, it is evident that PL imaging has the ability to ‘see through’ the wafer to reveal differently doped regions on the rear surface. Similarly, we expect that PL imaging will be able to reveal differently doped regions beneath the surface of a silicon sample, that may be formed for example by ion implantation, provided the carrier lifetime of the material is sufficient for photo-generated carriers to diffuse through the wafer to the differently doped regions before recombining. We have found that metallisation patterns on the rear surface of a silicon wafer can also be revealed with PL imaging.

For the PL images shown in FIGS. 2, 3, 6 and 7, the wafer was illuminated and the image acquired from the same surface. As described in the above-mentioned published PCT patent application No WO 2007/041758 A1, it is also possible for a sample to be illuminated and imaged from opposite sides, e.g. by illuminating the rear surface and imaging the front surface or vice versa. In general a selective emitter structure or some other pattern of compositional or doping variations should be detectable by PL imaging irrespective of the surfaces being illuminated and imaged.

The ability of PL imaging to see through or into a semiconductor wafer, demonstrated above with reference to FIG. 7, has potential applications in the manufacture or inspection of semiconductor devices with metallisation or doping patterns on the rear surface or on both the front and rear surfaces. We note that metallisation patterns on the rear surface are discernible with PL imaging and, while similar functionality is provided by optical imaging using IR wavelengths long enough to penetrate the wafer, there may be situations where it would be beneficial to be able to identify both metallisation and doping patterns on the rear surface of a wafer, e.g. to determine their relative positions. Similarly, it may be beneficial to be able to identify a metallisation pattern on the rear surface and a doping pattern on the front surface of a wafer. Certain high efficiency PV cells, such as metal wrap-through (MWT) and emitter wrap-through (EWT) cells for example, have metal or emitter structures on one or both surfaces. Another situation where it may be useful to reveal metallisation patterns on the rear surface of PV cells is tabbing during module assembly.

It will be observed that the contrast between the selective emitter structure (highly phosphorus-doped) and the surrounding lightly doped silicon is not consistent in the PL images discussed above. The highly phosphorus-doped regions appear brighter than the surrounding lightly-doped silicon in FIGS. 2 and 6 (selective emitter on front surface, before metallisation), but darker in FIG. 3 (selective emitter on front surface, after metallisation) and FIG. 7 (selective emitter on rear surface, before metallisation). The reasons for this are not clear. Ordinarily one would expect phosphorus doping to reduce the minority carrier lifetime of silicon so that more heavily doped regions would have a lower PL signal, consistent with the contrast observed in FIGS. 3 and 7. However there may be competing effects; for example the passivation, emitter patterning or metallisation processes could change some property of the front surface material, e.g. carrier lifetime or texture, which may affect the amount of PL escaping from that surface. The precise reasons for the different contrast patterns are essentially unimportant, as the PL-based methods of the present invention only require a discernible differential between the PL signals from the selective emitter regions and the surrounding material.

The foregoing examples have described the use of a PL intensity contrast as a differential for identifying doping variations in semiconductor materials. However a PL imaging system equipped with some form of wavelength selectivity, such as a monochromator or one or more optical filters, e.g. short pass, long pass or band pass filters, may in some cases be able to distinguish doping variations, e.g. differently doped regions, based on the wavelength range of the detected PL emission. This wavelength range could for example be affected by changes in band gap or re-absorption associated with doping variations, creating a measurable differential. Although variations in detected PL wavelength are expected to be small for the particular case of phosphorus-doped selective emitter structures in p-type silicon wafers, there may be other combinations of dopants and semiconductor materials, e.g. for direct band gap semiconductors used in LEDs and laser diodes, where doping variations significantly affect the PL emission wavelength. Other measurable differentials in PL signal, such as decay lifetime, may also be indicative of doping variations in semiconductor materials.

Because PL imaging is sensitive to variations in the doping level in silicon, it could also be used to monitor PV cell process steps that modify the doping level, such as partial etch-back of a heavily-doped emitter layer to produce a patterned emitter structure. The etch-back process could for example be stopped once the PL intensity contrast reached a predetermined level. In this context we note that, strictly speaking, it is not the PL from the doped layer itself that is being measured, but rather the effect the doped layer has on the effective carrier lifetime in the material, e.g. via the field effect surface passivation or some other effect that changes carrier recombination rates.

The invention has been described primarily in terms of silicon wafer-based PV cells and cell precursors with selective emitter structures, but is not so limited. It could for example be applicable to other devices with patterned doped regions, such as microelectronics devices, composed of silicon or some other semiconductor material from which photoluminescence can be generated. For devices with electrical contacts, it may also possible to identify doping variations using electroluminescence imaging.

Although the present invention has been described with particular reference to certain preferred embodiments thereof, variations and modifications of the present invention can be effected within the spirit and scope of the following claims.

1. A method for identifying variations in doping in a semiconductor material, said method comprising the steps of:
(a) illuminating said material with excitation light suitable for generating photoluminescence from said material;
(b) acquiring an image of the photoluminescence emitted from said material; and
(c) identifying said variations in doping based on a differential in said image.

2. A method according to claim 1, wherein said differential comprises an intensity contrast.

3. A method according to claim 1, wherein said differential comprises a wavelength variation.

4. A method according to claim 1, further comprising the step of: (d) forming on said material one or more optically visible markings indicative of the identified variations in doping.

5. A method according to claim 1, further comprising the step of: (e) determining the relative position between the identified variations in doping and one or more optically visible markings on said material.

6. A method according to claim 1, further comprising the step of: (f) utilising the identified variations in doping, to align said material for a subsequent step in the manufacture of a device from said material.

7. A method according to claim 1, further comprising the step of: (g) processing said image to obtain information on dislocations, cracks or low carrier lifetime regions in said material.

8. A method according to claim 1, further comprising the step of: (h) utilising the identified variations in doping, to reject said material or to adjust a parameter of a process step that produced said variations in doping.

9. A method according to claim 1, wherein said method is used to identify variations in doping comprising the position or orientation of a pattern of differently doped regions formed in or on a surface of said material.

10. A method according to claim 9, wherein said differently doped regions are in or on the surface of said material being illuminated and imaged.

11. A method according to claim 9, wherein said differently doped regions contain a dopant of opposite polarity to a background dopant in said material.

12. A method according to claim 1, wherein said method is applied to a material comprising a monocrystalline or multicrystalline silicon wafer or photovoltaic cell.

13. A method according to claim 1, wherein said image is acquired from a sub-area of said material.

14-31. (canceled)

32. A method for monitoring a process for producing variations in doping in a semiconductor material, said method comprising the steps of:
(a) illuminating said material with excitation light suitable for generating photoluminescence from said material;
(b) acquiring an image of the photoluminescence emitted from said material; and
(c) identifying, based on a differential in said image, variations in doping produced by said process.

33. A method according to claim 32, wherein said differential comprises an intensity contrast.

34. A method according to claim 32, wherein said differential comprises a wavelength variation.

35. A method according to claim 32, wherein said method is performed while said variations in doping are being produced.

36. A method according to claim 32, when used to monitor the formation of a selective emitter structure in or on a surface of said material.

37. A method according to claim 32, wherein said image is acquired from a sub-area of said material.

38-42. (canceled)

43. A system when used to perform the method according to claim 1.

44. An article of manufacture comprising a non-transitory computer usable medium having a computer readable program code configured to cause a system to perform the method according to claim 1.

45. A method according to claim 4, further comprising the step of: (f) utilising the identified variations in doping, or said optically visible markings, to align said material for a subsequent step in the manufacture of a device from said material.

46. A method according to claim 5, further comprising the step of: (f) utilising the identified variations in doping, or said optically visible markings, to align said material for a subsequent step in the manufacture of a device from said material.

47. A method according to claim 7, further comprising the step of: (h) utilising the identified variations in doping, or said information on dislocations, cracks or low carrier lifetime regions, to reject said material or to adjust a parameter of a process step that produced said variations in doping.

48. A method according to claim 10, wherein said differently doped regions contain a dopant of opposite polarity to a background dopant in said material.

49. A system when used to perform the method according to claim 32.

50. An article of manufacture comprising a non-transitory computer usable medium having a computer readable program code configured to cause a system to perform the method according to claim 32.
